(19) United States
(12) Patent Application Publication
(10) Pub. No.: US 2026/0194210 A1
(43) Pub. Date: Jul. 9, 2026

(54) Uniformly Luminous LED Optical System and Light Fixture

(71) Applicant: CHENGDU HERCULUX PHOTOELECTRIC TECHNOLOGY CO., LTD., Chengdu (CN)

(72) Inventors: Yongfeng HUO, Chengdu (CN); Yongyuan HUANG, Chengdu (CN); Qiang XIE, Chengdu (CN)

(21) Appl. No.: 18/838,622

(22) PCT Filed: Dec. 29, 2023
(86) PCT No.: PCT/CN2023/143120

§ 371 Date: Aug. 15, 2024

(30) Foreign Application Priority Data
Aug. 11, 2023 (CN) 202311016077.3

(51) Int. Cl. F21V 13/04; F21V 5/00; F21V 7/00; F21Y 103/33; F21Y 115/10

(52) U.S. Cl. CPC F21V 13/04; F21V 5/002; F21V 7/0066; F21Y 2103/33; F21Y 2115/10

(57) ABSTRACT

A uniformly luminous LED optical system and a lamp. The LED optical system includes a reflection cup and a lens. The lens is fixed to a light-exiting side of the reflection cup and includes a light-entering surface and a light-exiting surface. The light-entering surface is close to the reflection cup. The light-exiting surface is away from the reflection cup. A central incidence hole is in the bottom of the reflection cup. Assuming that a cross-section of the hole divides the reflection cup into two symmetrical parts, the cross-section curve l1 of the side wall of the reflection cup is a straight line a reverse arc line. The length of a straight line l2 formed by connecting two end points of the cross-sectional curve l1 is L. The straight line l2 is outside the reflection cup and intersects the cross-sectional curve l1 only at the two end points.

The present application claims the priority of Chinese patent application (application number, 202311016077.3) filed on Aug. 11, 2023.

### TECHNICAL FIELD

The present invention relates to the field of lighting, and in particular to a uniformly luminous LED optical system and a light fixture.

### BACKGROUND ART

In the LED reflector lamp field, the existing solution is a total reflection type lens or a reflection cup. These two light distribution methods have their own advantages and disadvantages.

As shown in FIGS. 1 and 2, the light rays of the total reflection lens will be incident from light-entering surfaces A and B, and then exit the lens from a surface C, which will generate interface reflection in multiple different directions, resulting in stray light. As shown in FIG. 3, the illumination distribution of the surface of the traditional total reflection lens is uneven, with obvious bright-dark boundary and bright center.

As shown in FIGS. 4-5, the light rays of the reflection cup are not controlled in the central part, resulting in a large light spot and a low light energy concentration degree. In order to effectively control the light, the reflection cup is designed in height higher than that of the lens, so that the requirements for assembly are higher.

Therefore, the use of the total reflection lens or the reflection cup alone does not achieve a good uniform light emission effect at present. It is necessary to improve the existing optical system to improve the uniformity of the emitted light.

### SUMMARY OF THE INVENTION

The object of the present invention is to provide a uniformly luminous LED optical system and a light fixture in view of the problem in the prior art that the use of a total reflection lens or a reflection cup alone does not achieve a good uniform light emission effect.

In order to achieve the above object, the technical solution adopted by the invention is as follows.

A uniformly luminous LED optical system comprises a reflection cup and a lens, wherein the lens is fixed to a light-exiting side of the reflection cup; the lens is provided with a light-entering surface and a light-exiting surface; the light-entering surface is located at a side close to the reflection cup; the light-exiting surface is located at a side away from the reflection cup; a central incidence hole is provided in the middle of the bottom surface of the reflection cup;
assuming that a cross-section through the central incidence hole divides the reflection cup into two symmetrical parts, the cross-sectional curve l1 of the side wall of the reflection cup is a straight line in the cross-sectional view; or
the cross-sectional curve l1 of the side wall is a reverse arc line; two end points of the cross-sectional curve l1 are point A and point B; the length of a straight line l1 formed by connecting the point A and the point B is L; the straight line l1 is located outside the reflection cup; the cross-sectional curve l1 intersects the straight line l2 only at the point A and the point B; and the maximum vertical distance of the cross-sectional curve l1 from the straight line l2 is H, and 0≤H/L≤0.035.

Preferably, the light-entering surface is provided with a beaded surface microstructure.

Preferably, the beaded surface microstructure is a square microstructure or a hexagonal microstructure.

Preferably, the projection of the light-entering surface on the reflection cup is a square or circular surface.

Preferably, the light-entering surface and/or the light-exiting surface is provided with a broadband ar coating.

Preferably, it further comprises a polarized optical sheet or a uniformly luminous optical sheet, wherein the polarized optical sheet or the uniformly luminous optical sheet is disposed on a light-exiting side of the lens and spaced apart from the lens.

Preferably, the polarized optical sheet is a single polarized optical sheet or a dual polarized optical sheet.

Preferably, the single polarized optical sheet or the dual polarized optical sheet further comprises a rib or a frosted structure disposed on one side of a membrane.

Preferably, the minimum distance of the polarized optical sheet or the uniformly luminous optical sheet from the lens is less than or equal to 6 mm.

Preferably, the lens comprises a plurality of specifications, the lens being fittingly connected to the reflection cup.

An LED light fixture comprises an LED linear lamp optical system according to any one of the above-mentioned.

Preferably, the light fixture is a linear lamp; and the light fixture is provided with a plurality of optical systems.

Preferably, the linear lamp is in the shape of a bar, a sector or a circle.

In summary, due to the adoption of the technical solution, the invention has the following beneficial effects.

The uniformly luminous LED optical system of the present invention combines the advantages of the traditional reflection cup and lens. By providing an optical system combining the reflection cup and the lens, the reflection cup is firstly used to control the light, and then the lens is used to control the light. It is possible to make the central uncontrolled light coincide with the edge reflected light energy as much as possible before the light enters the lens via the reflection cup, so as to obtain a relatively uniform light spot on the light-entering surface of the lens. Since the center of the lens is thick and the edge is thin, the best distribution of the light spot is that the center is brightest and then the light spot can uniformly transition to the edge, so as to improve the uniformity of the lens surface. The problem of uncontrolled light in the central part of reflection cup is solved.

The reverse arc is designed such that after a part of the light passes through the reflective surface of the reflection cup, the light energy is nearly coincident with another part of the light that does not pass through the reflective surface, thus allowing the light energy of the two parts of light energy to be distributed approximately uniformly via one lens.

### BRIEF DESCRIPTION OF THE DRAWINGS

FIG. 1 is a schematic view of a structure of a total reflection lens described in the background art.

FIG. 2 is an optical path diagram of a total reflection lens described in the background art.

FIG. 3 is a surface illuminance distribution graph of a total reflection lens described in the background art.

FIG. 4 is an optical path diagram of a reflection cup described in the background art.

FIG. 5 is a surface illuminance distribution graph of a reflection cup described in the background art.

FIG. 6 is a schematic diagram showing a three-dimensional structure of a uniformly luminous LED optical system according to the present invention.

FIG. 7 is a cross-sectional view of a uniformly luminous LED optical system according to the present invention.

FIG. 8 is an illuminance distribution graph of the uniformly luminous LED optical system according to Embodiment 1 of the present invention.

FIG. 9 is a cross-sectional view of the LED optical system according to Embodiment 3 of the present invention.

FIG. 10 is a structurally schematic diagram of a side wall of the LED optical system according to Embodiment 3 of the present invention.

FIG. 11 is an optical path diagram of a sidewall of the LED optical system according to Embodiment 3 of the present invention.

FIG. 12 is a structurally schematic diagram of the sidewall at H/L=0.0098.

FIG. 13 is an illuminance distribution graph of the optical system at H/L=0.0098.

FIG. 14 is a structurally schematic diagram of the sidewall at H/L=0.04.

FIG. 15 is an illuminance distribution graph of the optical system at H/L=0.04.

FIG. 16 is a structurally schematic diagram of the side wall when a straight line 12 is positioned inside the reflection cup 1.

FIG. 17 is an illuminance distribution diagram of the optical system when the straight line l2 is located inside the reflection cup 1.

FIG. 18 is a structurally schematic diagram of the side wall when there are three intersections between the section curve l1 and the straight line l2.

FIG. 19 is an illuminance distribution diagram of the optical system when there are three intersections between the section curve l1 and the straight line l2.

FIG. 20 is a schematic diagram showing a three-dimensional structure of a lens according to the invention.

FIG. 21 is a cross-sectional view of a lens according to the present invention.

FIG. 22 is a side view of a lens according to the present invention.

FIG. 23 is a simulated optical path diagram without beaded surface microstructures.

FIG. 24 is a simulated optical path diagram with beaded surface microstructures.

FIG. 25 is a simulated light spot diagram without beaded surface microstructures.

FIG. 26 is a simulated light spot diagram with square microstructures.

FIG. 27 is a simulated light spot diagram with hexagonal microstructures.

FIG. 28 is a simulated light spot diagram without broadband antireflective treatment of the lens surface.

FIG. 29 is a simulated light spot diagram with broadband antireflective treatment of the lens surface.

FIG. 30 is a three-dimensional structural view in which a single polarized optical sheet is provided.

FIG. 31 is a three-dimensional structural view of a single polarized optical sheet.

FIG. 32 is a cross-sectional view of a single polarized optical sheet.

FIG. 33 is an optical path diagram of a single polarized optical sheet.

FIG. 34 is a three-dimensional structural view in which a dual polarized optical sheet is provided.

FIG. 35 is a three-dimensional structural view of a dual polarized optical sheet.

FIG. 36 is a cross-sectional view of a dual polarized optical sheet.

FIG. 37 is an optical path diagram of a dual polarized optical sheet.

FIG. 38 is a three-dimensional structural view in which a uniformly luminous optical sheet is provided.

FIG. 39 is a three-dimensional structural view of the uniformly luminous optical sheet.

FIG. 40 is a cross-sectional view of a uniformly luminous optical sheet.

FIG. 41 is an optical path diagram of the uniformly luminous optical sheet.

FIG. 42 is a schematic diagram I of a three-dimensional structure of a linear lamp in the form of a bar.

FIG. 43 is a schematic diagram II of a three-dimensional structure of a linear lamp in the form of a bar.

FIG. 44 is a structurally schematic diagram of a light-entering surface of the lens of the linear lamp in the form of a bar.

FIG. 45 is an overall schematic view of a light fixture for linear lamp in the form of a bar (with part of the heat sink hidden).

FIG. 46 is a schematic diagram showing a three-dimensional structure of linear lamp in the form of a fan shape.

FIG. 47 is a schematic diagram showing a three-dimensional structure of a circular linear lamp.

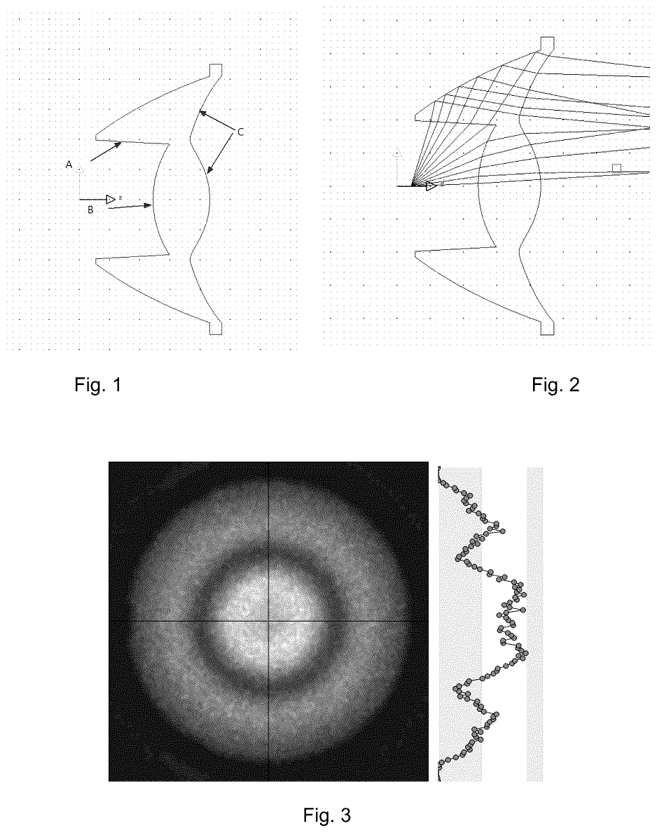

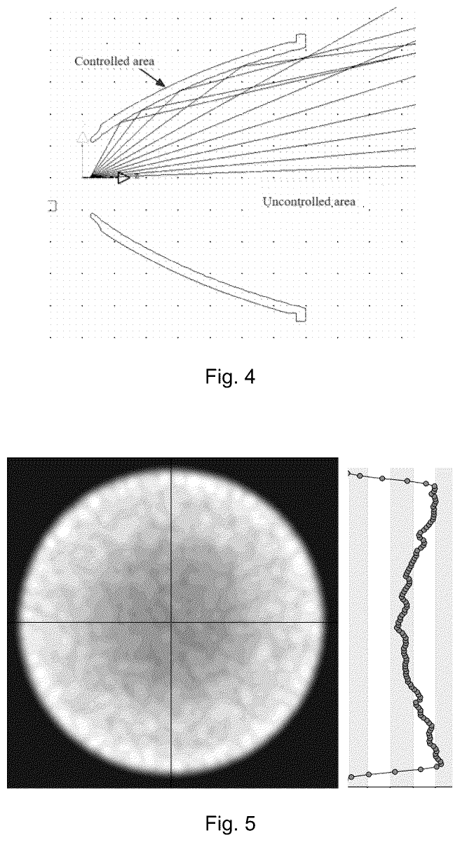

### REFERENCE NUMERALS

1-reflection cup, 11-central incidence hole, 12-side wall, 2-lens, 21-light-entering surface, 22-light-exiting surface, 23-square microstructure, 24-hexagonal microstructure, 31-single polarized optical sheet, 311-Fresnel lens, 32-dual polarized optical sheet, 321-dual polarized microstructure, 322-rib, 4-uniformly luminous optical sheet, 41-rib microstructure, 5-first connection structure, 6-second connection structure, 7-LED light source, 8-heat sink.

### DETAILED DESCRIPTION

Hereinafter, the invention will be described in detail with reference to the accompanying drawings.

In order that the objects, aspects, and advantages of the invention will become more apparent, a more particular description of the invention will be rendered by reference to the appended drawings and embodiments. It should be understood that the specific examples described herein are merely used for explanation of the invention and are not intended to be limiting thereof.

### Embodiment 1

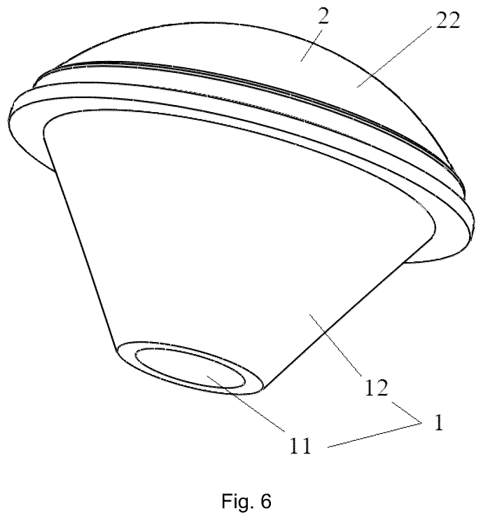

As shown in FIG. 6, a uniformly luminous LED optical system includes a reflection cup 1 and a lens 2. The lens 2 is fixed to a light-exiting side of the reflection cup 1. The reflection cup 1 and the lens 2 may be assembled and connected or may be integrally formed. Preferably, the lens 2 includes a plurality of specifications, so that it can be freely assembled with the reflection cup 1 in different forms of combined structure to adapt to the lighting requirements of different light fixtures.

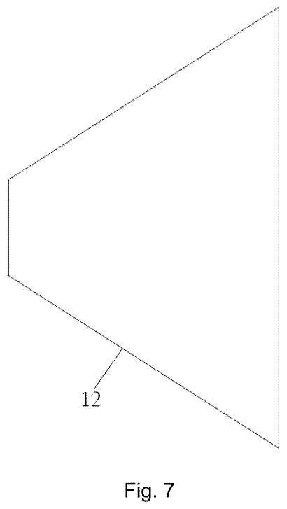

A central incidence hole 11 is provided in the middle of the bottom surface (a surface away from the reflection cup 1) of the reflection cup 1. The side wall 12 of the reflection cup 1 is a rotating surface, and the generatrix of the side wall 12 is a straight line, as shown in FIG. 7. The lens 2 is provided with an light-entering surface 21 and an light-exiting surface 22. The light-entering surface 21 is located at a side close to the reflection cup 1. The light-exiting surface 22 is located at a side away from the reflection cup 1.

In this embodiment, the uniformly luminous LED optical system of the present invention combines the advantages of the traditional reflection cup and lens. By providing an optical system combining the reflection cup and the lens, the reflection cup is firstly used to control the light, and then the lens is used to control the light. It is possible to make the central uncontrolled light coincide with the edge reflected light energy as much as possible before the light enters the lens via the reflection cup, so as to obtain a relatively uniform light spot on the light-entering surface of the lens. Since the center of the lens is thick and the edge is thin, the best distribution of the light spot is that the center is brightest and then the light spot can uniformly transition to the edge, so as to improve the uniformity of the lens surface. The problem of uncontrolled light in the central part of reflection cup is solved.

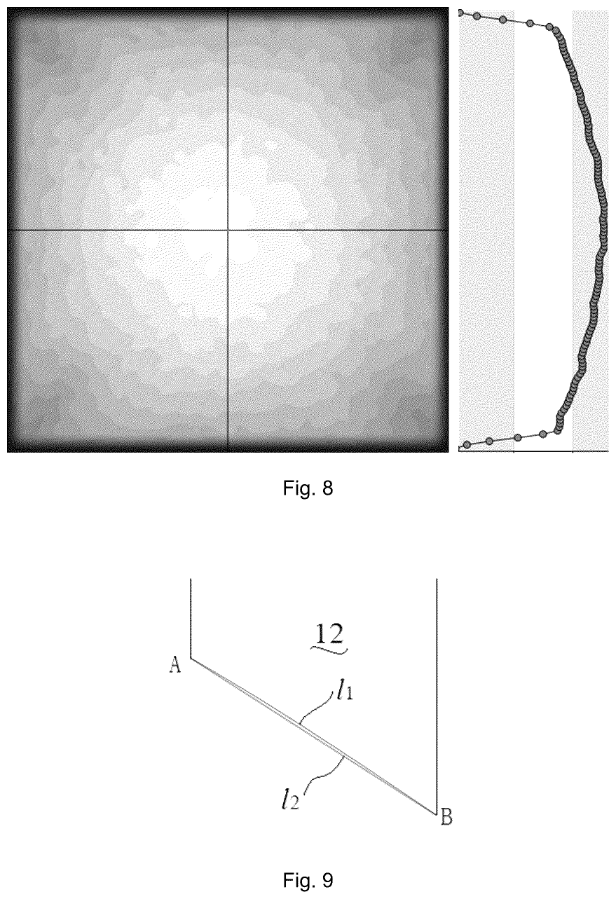

As shown in FIG. 8, by using the uniformly luminous LED optical system as described in this embodiment, it is possible to achieve uniform light ray illumination transition on the light-entering surface of the lens, and the uniformity of the integrally formed light spot is better.

### Embodiment 2

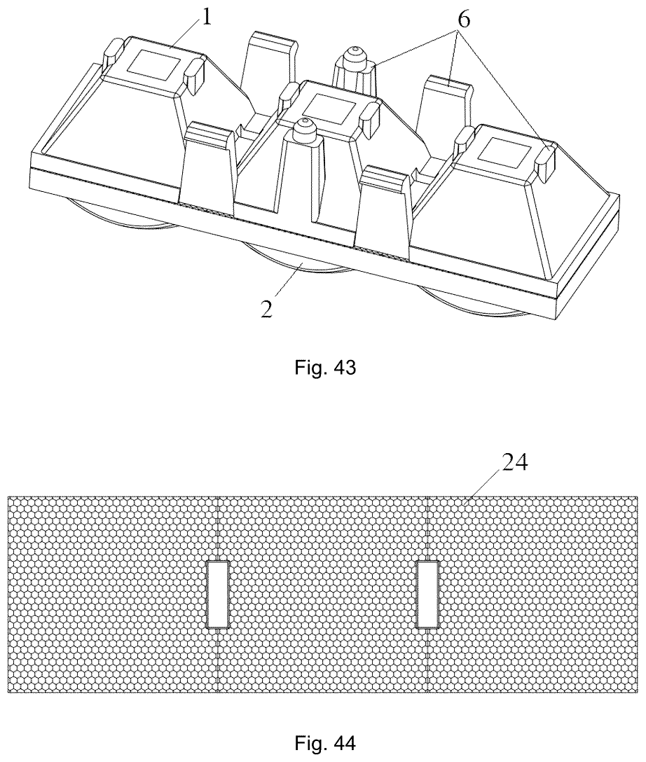

This embodiment differs from embodiment 1 in that the side wall 12 of the reflection cup 1 in this embodiment includes several obliquely arranged planes, for example four, as shown in FIGS. 42-43, all obliquely arranged planes enclosing a curved side wall structure. By the same reasoning, for the uniformly luminous LED optical system as described in this embodiment, it is also possible to achieve uniform light ray illumination transition on the light-entering surface of the lens, and the uniformity of the integrally formed light spot is better.

### Embodiment 3

As shown in FIG. 6, a uniformly luminous LED optical system includes a reflection cup 1 and a lens 2. The lens 2 is fixed to a light-exiting side of the reflection cup 1. The reflection cup 1 and the lens 2 may be assembled and connected or may be integrally formed. The lens 2 is provided with an light-entering surface 21 and an light-exiting surface 22. The light-entering surface 21 is located at a side close to the reflection cup 1. The light-exiting surface 22 is located at a side away from the reflection cup 1.

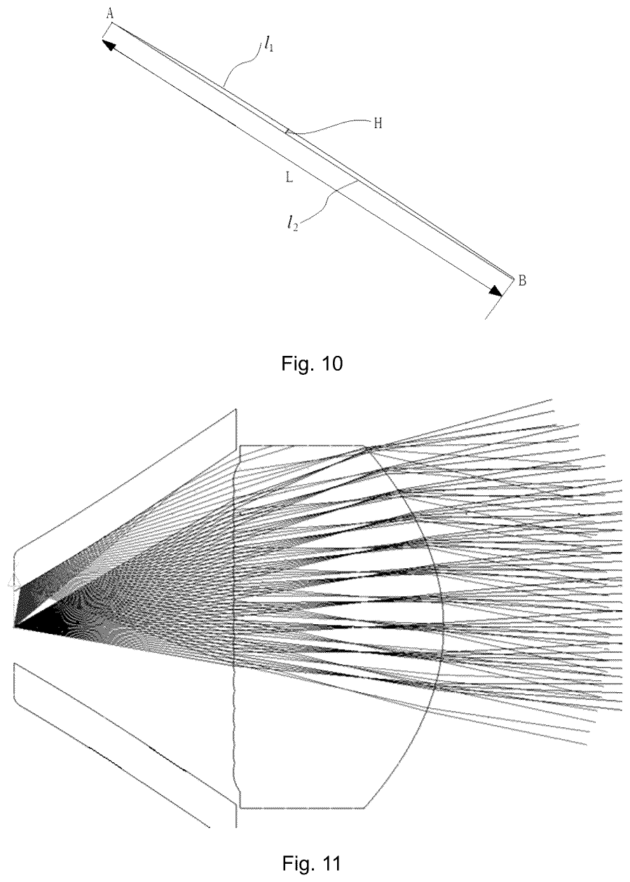

A central incidence hole 11 is provided in the middle of the bottom face (a surface away from the reflection cup 1) of the reflection cup 1. As shown in FIGS. 9 and 10, assuming that a cross-section through the central point of the central incidence hole 11 divides the reflection cup 1 into two symmetrical components, the cross-sectional curve l1 of the side wall 12 of the reflection cup 1 is a reverse arc in the cross-sectional view. Two end points of the cross-sectional curve l2 are respectively a point A and a point B. A straight line formed by the points A and B is l2 . The length of the straight line l2 is L, and the straight line l2 is located outside the reflection cup 1. The cross-sectional curve Il intersects the straight line l2 only at the points A and B. The maximum vertical distance of the cross-sectional curve Il from the straight line l2 is H, and 0≤H/L≤0.035.

As shown in FIG. 11, the reflection cup side wall 12 is designed such that after a part of the light passes through the reflective surface of the reflection cup, the light energy is nearly coincident with another part of the light that does not pass through the reflective surface, thus allowing the light energy of the two parts of light energy to be distributed approximately uniformly via one lens.

In this embodiment, the uniformly luminous LED optical system of the present invention combines the advantages of the traditional reflection cup and lens. By providing an optical system combining the reflection cup and the lens, the reflection cup is firstly used to control the light, and then the lens is used to control the light. It is possible to make the central uncontrolled light coincide with the edge reflected light energy as much as possible before the light enters the lens via the reflection cup, so as to obtain a relatively uniform light spot on the light-entering surface of the lens. Since the center of the lens is thick and the edge is thin, the best distribution of the light spot is that the center is brightest and then the light spot can uniformly transition to the edge, so as to improve the uniformity of the lens surface. The problem of uncontrolled light in the central part of reflection cup is solved.

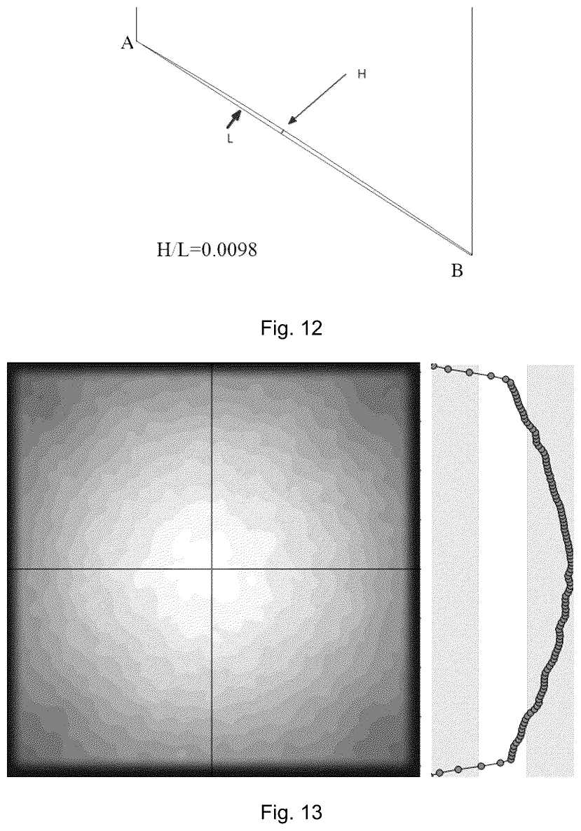

As a preferred implementation, as shown in FIGS. 12 and 13, when H/L=0.0098, by using the uniformly luminous LED optical system as described in this embodiment, it is possible to achieve uniform light ray illumination transition on the light-entering surface of the lens, and the uniformity of the integrally formed light spot is better.

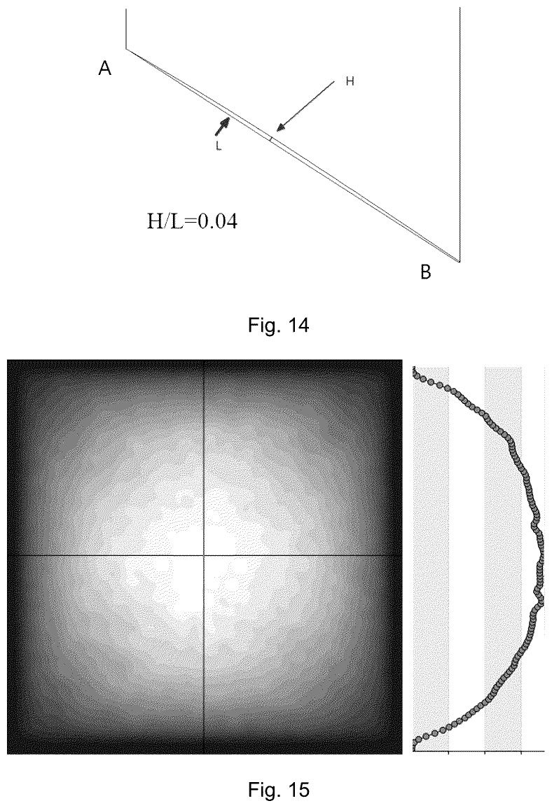

As a comparative example, as shown in FIGS. 14-15, when H/L=0.04, the illuminance of the light-entering surface of the lens is too bright in the middle and too dark at the edge, which is unfavorable for the uniform distribution of the energy of the lens, resulting in poor uniformity of the light spot.

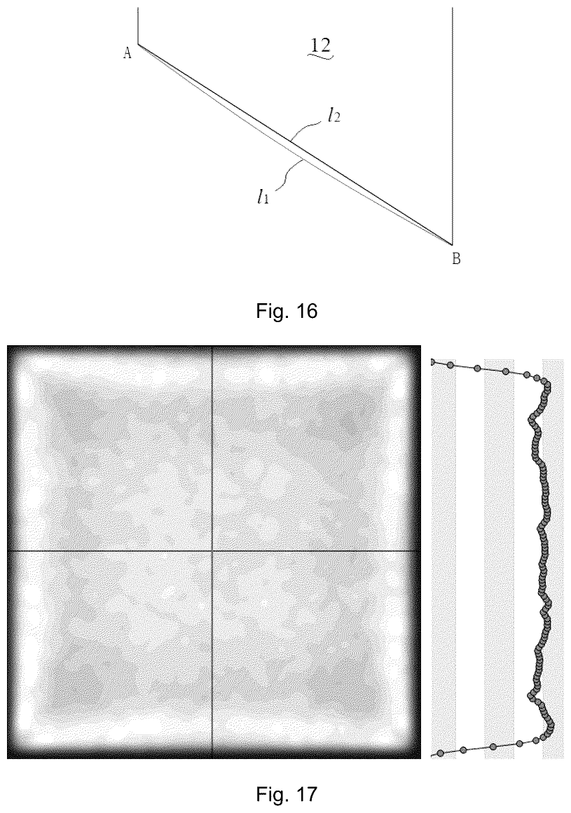

As a comparative example, as shown in FIGS. 16 and 17, when the straight line 12 is located inside the reflection cup 1, the edge of the illuminance of the light-entering surface of the lens is bright and the center is dark, which is not conducive to the uniform distribution of the energy of the lens, resulting in poor uniformity of the light spot.

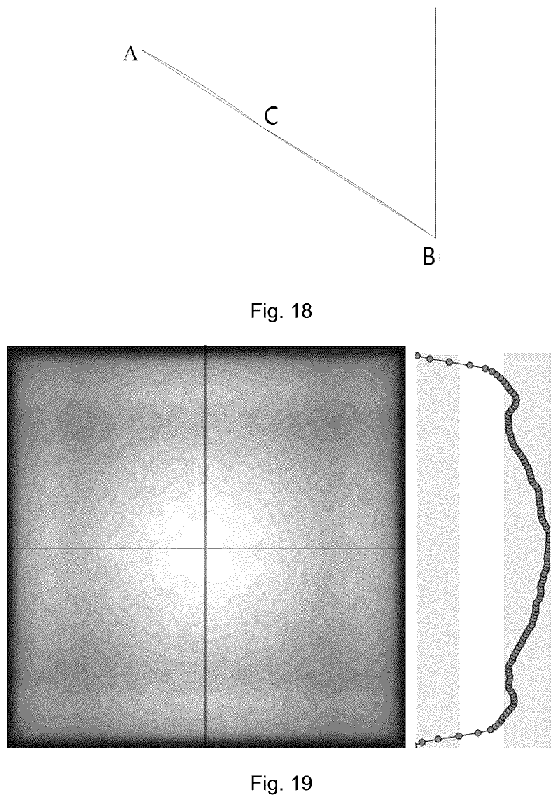

As a comparative example, as shown in FIGS. 18-19, when there are three intersection points (points A, B and C, respectively) between the cross-sectional curve l1 and the straight line l2, the illuminance of the light-entering surface of the lens is not uniform, resulting in poor uniformity of the light spot.

### Embodiment 4

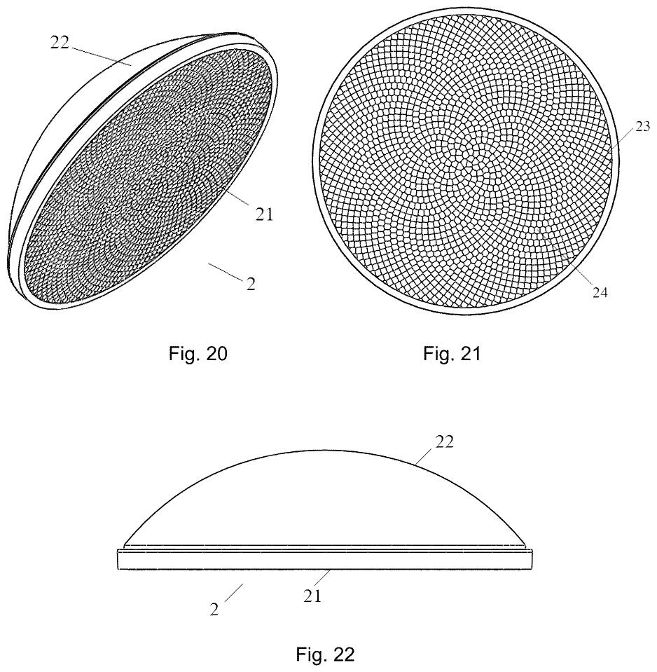

On the basis of the embodiments 1-3, the present embodiment optimizes the design of the lens 2. Specifically, as shown in FIGS. 20-22, a beaded surface microstructure is added to the light-entering surface 21 of the lens 2. The beaded surface microstructure is a square microstructure 23 or a hexagonal microstructure 24. Specifically, a person skilled in the art would understand that only a square microstructure 23 may be provided on the light-entering surface 21 of the lens 2, or only a hexagonal microstructure 24 may be provided on the light-entering surface 21 of the lens 2, or both the square microstructure 23 and the hexagonal microstructure 24 may be provided on the light-entering surface 21 of the lens 2.

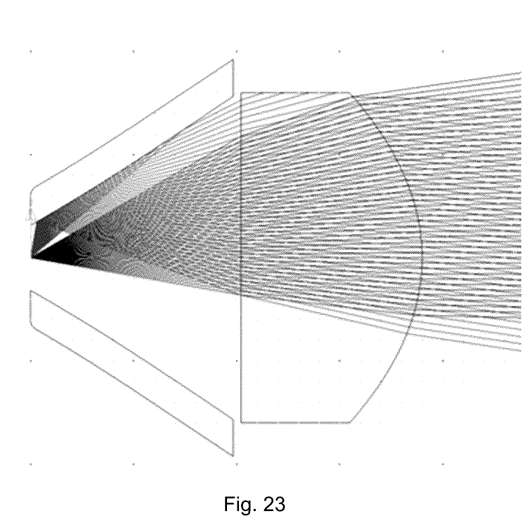

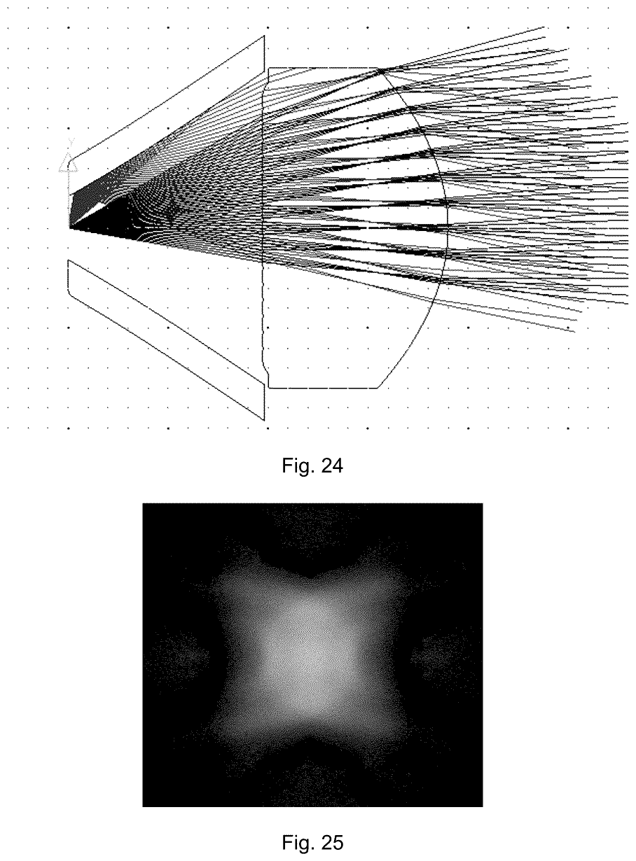

FIG. 23 shows a simulated light path diagram without a beaded surface microstructure, and FIG. 24 shows a simulated light path diagram with a beaded surface microstructure. It can be seen that bead surface microstructure is made inside the lens, so that the energy of reflected light and non-reflected light may be combined more uniformly, thereby obtaining a relatively uniform light spot.

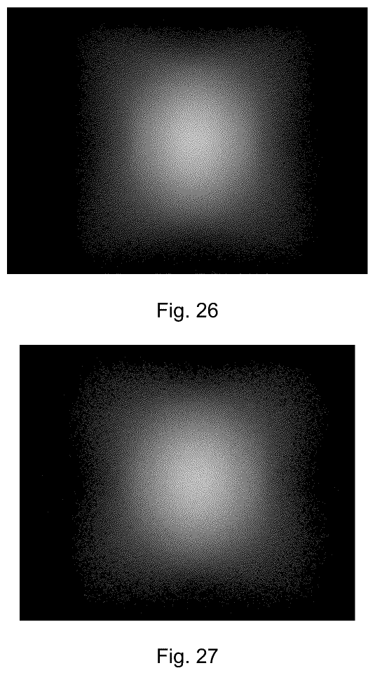

Furthermore, FIG. 25 shows a simulated light spot diagram without a bead surface microstructure, and it can be seen therefrom that the simulated light spot is layered when no microstructure is added inside the lens. FIG. 26 shows a simulated light spot diagram provided with a square microstructure, and it can be seen therefrom that the light spot may be smoothed uniformly by making a square microstructure inside the lens, so that the light spot is uniform. FIG. 27 shows a simulated light spot diagram provided with a hexagonal microstructure, and it can be seen therefrom that making a hexagonal microstructure inside the lens may smooth the light spot and make the light spot uniform.

### Embodiment 5

On the basis of embodiments 1-4, this embodiment optimizes the design of the lens 2. Specifically, the light-entering surface 21 and/or the light-exiting surface 22 of the lens 2 is provided with a broadband ar coating.

The LED light is reflected by the reflection cup, concentrated on the lens, and then refracted out of the optical system by the convex lens, where the surface of the lens is coated with an ar coating to reduce the interface reflection. It concentrates the advantages of the reflection cup and the lens, and can further make the designed light fixture have the following features: 1, the surface illuminance is uniform; 2, the glare is low; and 3, the light energy is concentrated.

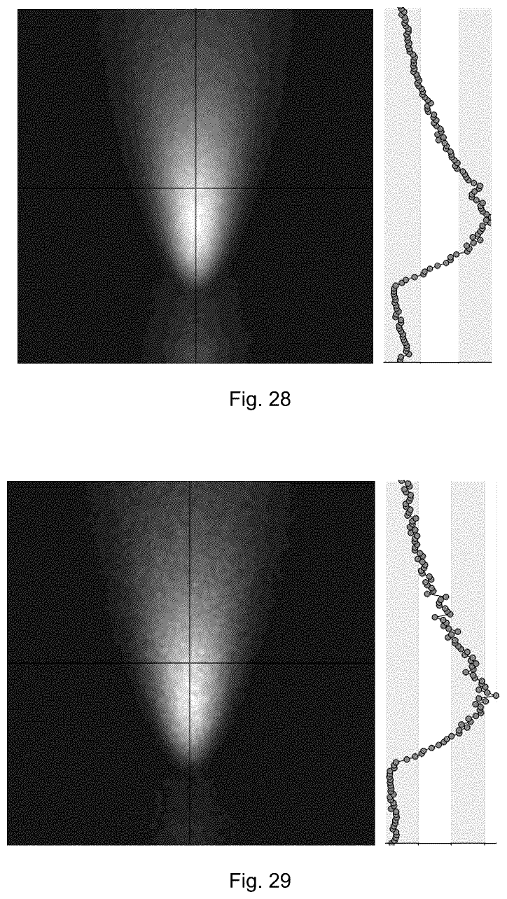

As shown in FIGS. 28-29, the broadband antireflection treatment on the lens surface may effectively reduce the spot stray light caused by interface reflection, so that the illumination is more uniform.

It will be understood by those skilled in the art that the projection of the light-entering surface 21 on the reflection cup 1 may be a square surface or a circular surface. The circular surface is a common cross-section, which is easy to manufacture and has low processing cost, while square surface may further increase the light output area and improve the lighting efficiency.

### Embodiment 6

In addition to the embodiments 1-5, a polarized optical sheet is further provided in this embodiment. The polarized optical sheet is provided on the light-exiting side of the lens 2 and spaced apart from the lens 2. The closer the distance between the polarized optical sheet and the lens 2 is, the better. The closer the distance between the two is, the smaller the overall size of the light fixture is, which is beneficial to saving materials, reducing processing costs and improving the flexibility of optical system installation. Preferably, the minimum distance between the polarized optical sheet and the lens 2 is less than or equal to 10 mm. Further preferably, the minimum distance between the polarized optical sheet and the lens 2 is less than or equal to 6 mm.

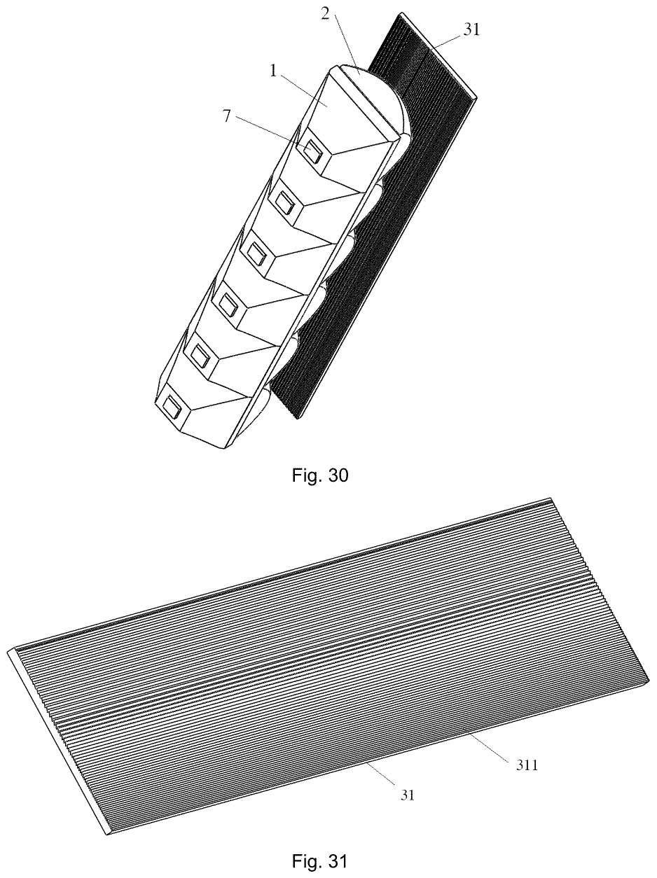

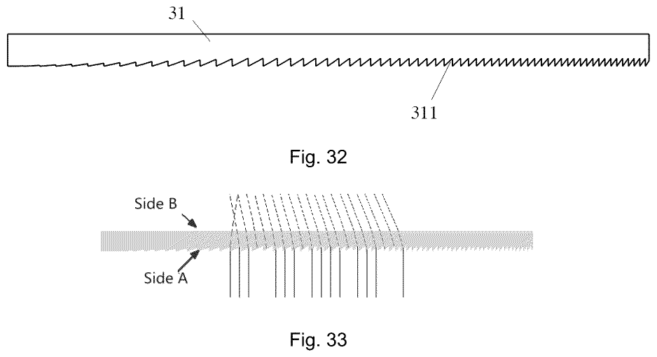

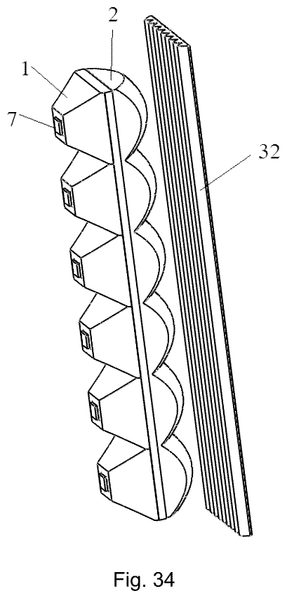

Specifically, as shown in FIGS. 30-32, in the present embodiment, the polarized optical sheet is a single polarized optical sheet 31. The side A of the single polarized optical sheet 31 is provided with a Fresnel lens 311, which can realize the deflection of light rays so as to refract light spots with better uniformity out of the light fixture. Preferably, the side B of the single polarized optical sheet 31 may be further provided with a ridge or a frosted structure for further smoothing, as shown in FIG. 33.

The present invention can obtain different light distribution effects merely by changing the shape or size of the polarized optical sheet, and thus can further satisfy the use requirements of different light fixtures. Therefore, it is possible to realize mass production, further reduce processing costs, and have significant economic benefits.

### Embodiment 7

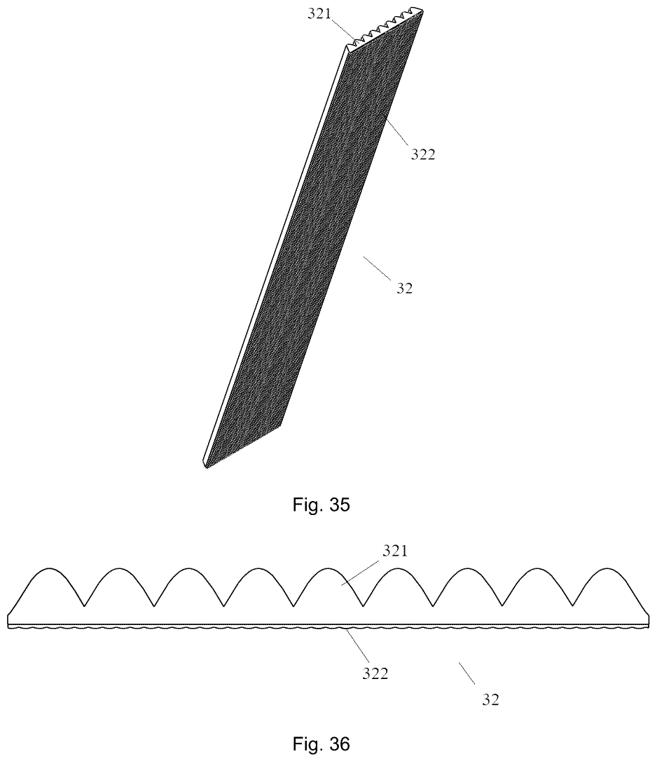

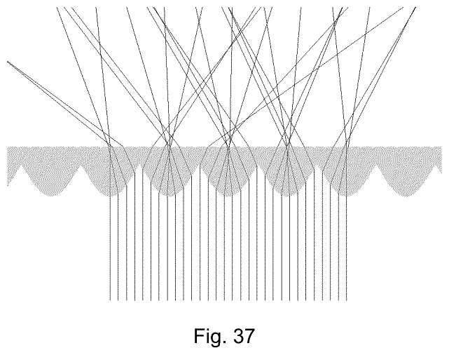

As shown in FIGS. 34-36, this embodiment differs from Embodiment 6 in that the polarized optical sheet in this embodiment is a dual polarized optical sheet 32. One side of the dual polarized optical sheet 32 is provided with a dual polarized microstructure 321, which is a semi-circular or tapered strip-shaped protrusion. The cross section of the dual polarized microstructure 321 is an axisymmetric structure. The dual polarized microstructure 321 has two symmetrical light distribution surfaces, so as to achieve the effect of dual polarization. Further preferably, the other side of the dual polarized optical sheet 32 is provided with a rib 322, and the diameter of the dual polarized microstructure 321 is greater than that of the rib 322. The dual polarized microstructure 321 is responsible for polarization and the rib 322 is responsible for uniform light distribution, as shown in FIG. 37.

### Embodiment 8

On the basis of the embodiments 1-5, this embodiment further includes a uniformly luminous optical sheet 4. The uniformly luminous optical sheet 4 is provided on the light-exiting side of the lens 2 and is spaced apart from the lens 2. The closer the distance between the uniformly luminous optical sheet 4 and the lens 2 is, the better. The closer the distance between the two is, the smaller the overall size of the light fixture is, which is beneficial to saving materials, reducing processing costs and improving the flexibility of optical system installation. Preferably, the minimum distance between the uniformly luminous optical sheet 4 and the lens 2 is less than or equal to 10 mm. Further preferably, the minimum distance between the uniformly luminous optical sheet 4 and the lens 2 is less than or equal to 6 mm.

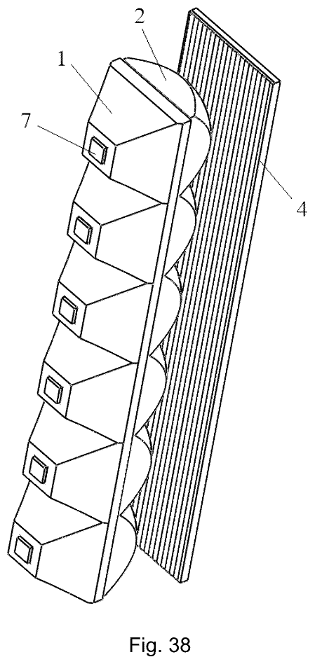

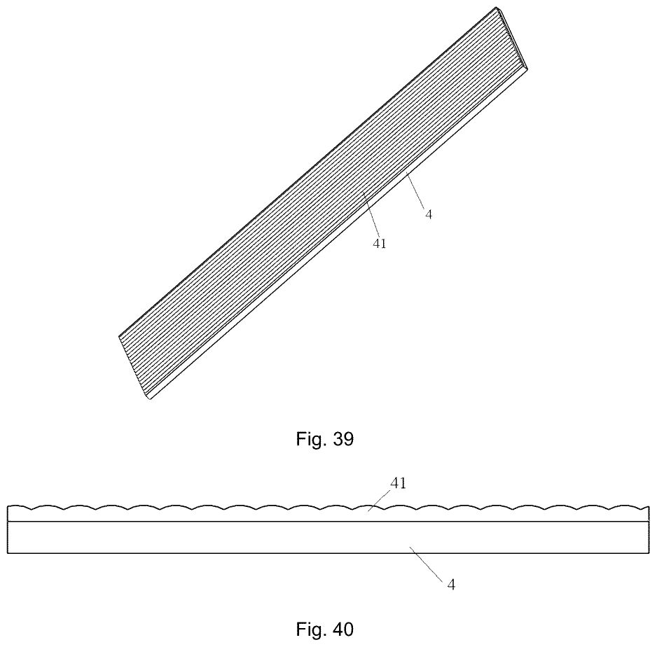

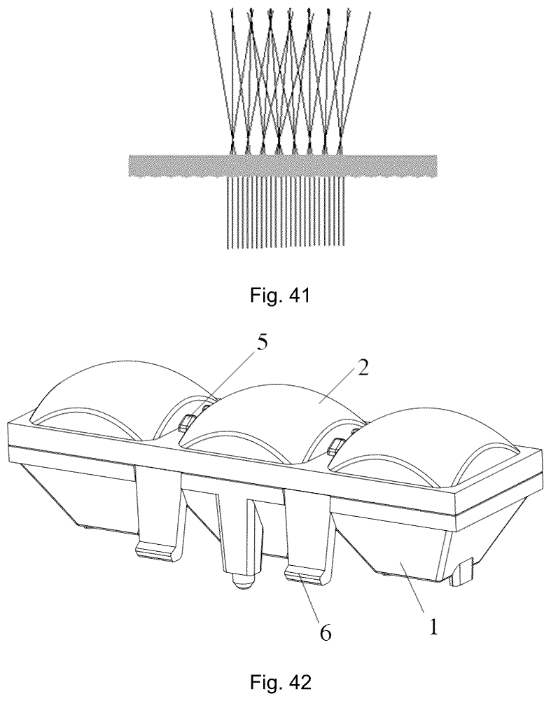

In this embodiment, as shown in FIGS. 38-40, the uniformly luminous optical sheet 4 includes rib microstructures 41 arranged on one or both sides of a membrane. The rib microstructures 41 are strip-shaped protrusions arranged in a linear manner. The rib microstructure 41 can be made with different radii and sizes so as to achieve different uniform light effects. It is also possible to directly arrange frosting on one surface so that the light spot further obtains a uniform light effect, as shown in FIG. 41.

The present invention can obtain different light distribution effects merely by changing the shape or size of the uniformly luminous optical sheet 4, and thus can further satisfy the use requirements of different light fixtures. Therefore, it is possible to realize mass production, further reduce processing costs, and have significant economic benefits.

### Embodiment 9

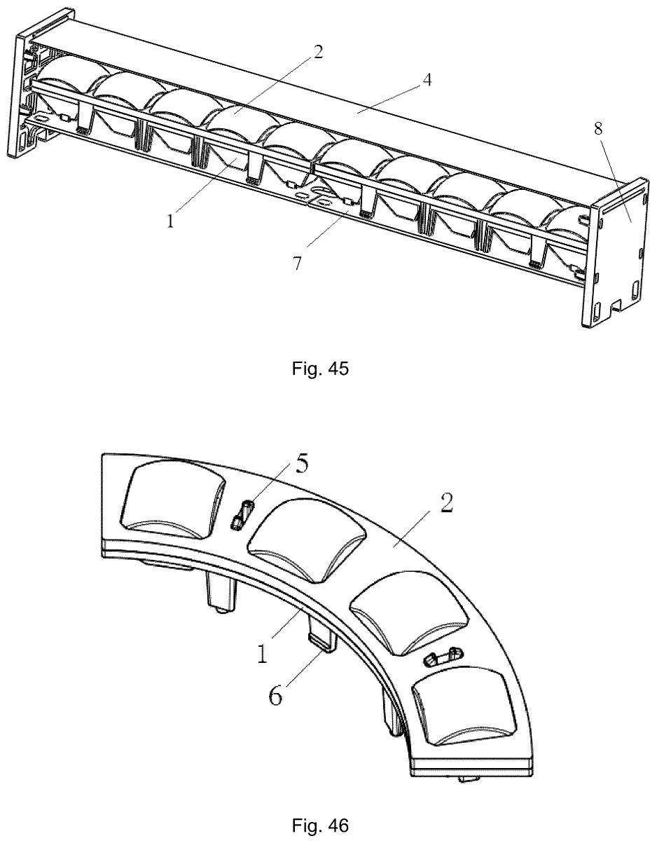

As shown in FIGS. 42-45, an LED light fixture includes an LED linear lamp optical system as described in any of embodiments 1-8. Specifically, in the present embodiment, the light fixture is a linear lamp. The shape of the linear lamp is a strip-shaped. A plurality of the optical systems are provided on the light fixture, and an LED light source 7 is mounted on a central incidence hole 11 of the reflection cup 1.

Furthermore, in order to achieve the heat dissipation of the light fixture and the assembly of the reflection cup 1 and the lens 2. Usually, the light fixture may also be provided with a heat sink 8, and a first connection structure 5 and a second connection structure 6 are provided. The first connection structure 5 may achieve the assembly connection of the reflection cup 1 and the lens 2. For example, the first connection structure 5 may include a snap connection member (a snap, a snap groove, a positioning post, etc.). The second connection structure 6 may realize the assembly connection of the reflection cup 1 and the light fixture. For example, the second connection structure 6 also includes a snap connection member (a snap, a snap groove, a positioning post, etc.).

### Embodiment 10

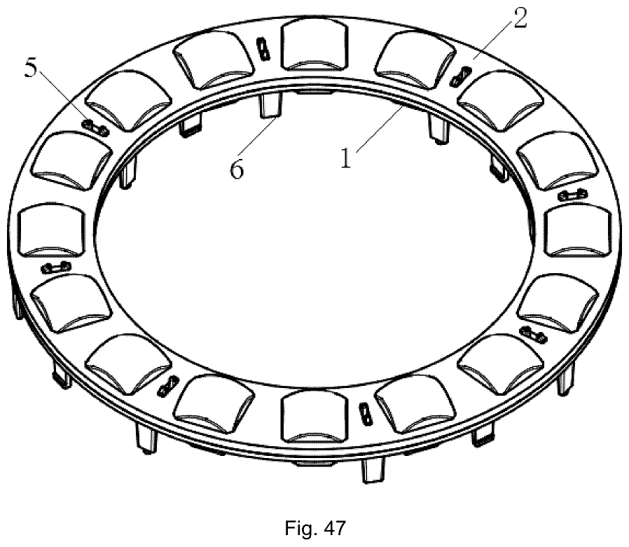

As shown in FIG. 46, this embodiment differs from the embodiment 9 in that the shape of the linear lamp in this embodiment is a sector (namely, the central axis thereof is an arc line).

### Embodiment 11

As shown in FIG. 47, this embodiment differs from the embodiment 9 in that the shape of the linear lamp in this embodiment is circular (namely, the central axis thereof is a circle).

The above mentioned are only preferred embodiments of the invention and is not intended to limit the invention. Any modification, equivalent substitution and improvement made within the spirit and principles of the invention shall be covered by the protection of the invention.

1. A uniformly luminous LED optical system comprises a reflection cup (1) and a lens (2), wherein the lens (2) is fixed to a light-exiting side of the reflection cup (1); the lens (2) is provided with a light-entering surface (21) and a light-exiting surface (22); the light-entering surface (21) is located at a side close to the reflection cup (1); the light-exiting surface (22) is located at a side away from the reflection cup (1); a central incidence hole (11) is provided in the middle of the bottom surface of the reflection cup (1);
assuming that a cross-section through the central incidence hole (11) divides the reflection cup (1) into two symmetrical parts, the cross-sectional curve l1 of the side wall (12) of the reflection cup (1) is a straight line in the cross-sectional view; or
the cross-sectional curve l1 of the side wall (12) is a reverse arc line; two end points of the cross-sectional curve l1 are point A and point B; the length of a straight line l2 formed by connecting the point A and the point B is L; the straight line l2 is located outside the reflection cup (1); the cross-sectional curve l1 intersects the straight line l2 only at the point A and the point B;
and the maximum vertical distance of the cross-sectional curve l1 from the straight line l2 is H, and 0≤H/L≤0.035.

2. The uniformly luminous LED optical system according to claim 1, wherein the light-entering surface (21) is provided with a beaded surface microstructure.

3. The uniformly luminous LED optical system according to claim 2, wherein the beaded surface microstructure is a square microstructure (23) or a hexagonal microstructure (24).

4. The uniformly luminous LED optical system according to claim 1, wherein the projection of the light-entering surface (21) on the reflection cup (1) is a square or circular surface.

5. The uniformly luminous LED optical system according to claim 1, wherein the light-entering surface (21) and/or the light-exiting surface (22) is provided with a broadband anti reflection coating.

6. The uniformly luminous LED optical system according to claim 1, further comprising a polarized optical sheet or a uniformly luminous optical sheet (4), wherein the polarized optical sheet or the uniformly luminous optical sheet (4) is disposed on a light-exiting side of the lens (2) and spaced apart from the lens (2).

7. The uniformly luminous LED optical system according to claim 6, wherein the polarized optical sheet is a single polarized optical sheet (31) or a dual polarized optical sheet (32).

8. The uniformly luminous LED optical system according to claim 7, wherein the single polarized optical sheet (31) or the dual polarized optical sheet (32) further comprises a rib or a frosted structure disposed on one side of a membrane.

9. The uniformly luminous LED optical system according to claim 6, wherein the minimum distance of the polarized optical sheet or the uniformly luminous optical sheet (4) from the lens (2) is less than or equal to 6 mm.

10. The uniformly luminous LED optical system according to claim 1, wherein the lens (2) comprises a plurality of specifications, the lens (2) being fittingly connected to the reflection cup (1).

11. An LED light fixture comprises an LED linear lamp optical system according to claim 1.

12. The LED light fixture according to claim 11, wherein the light fixture is a linear lamp; and the light fixture is provided with a plurality of optical systems.

13. The LED light fixture according to claim 12, wherein the linear lamp is in the shape of a bar, a sector or a circle.
